(19) United States
(12) Patent Application Publication
(10) Pub. No.: US 2010/0323931 A1
(43) Pub. Date: Dec. 23, 2010

(54) STABILISED EMULSIONS

(75) Inventors: John Crawshaw, Newmarket (GB); Gary Tustin, Cambridge (GB)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: Schlumberger Technology Corporation, Cambridge, MA (US)

(21) Appl. No.: 12/486,385

(22) Filed: Jun. 17, 2009

(51) Int. Cl. C09K 8/68

(52) U.S. Cl. 507/219; 507/200

(57) ABSTRACT

A method and system are described in which a first composition may be delivered to a target location, which target location may include but is not limited to a location in a wellbore penetrating an earth formation. The first composition is dispersed into a second composition to form an emulsion, where the emulsion is stabilized by particles that are responsive to a magnetic field. The emulsion is used to transport the first composition to the target location where the emulsion is subjected to a magnetic field sufficient to interact with the particles and disrupt the emulsion, and thereby change the viscosity of the composition and/or release the first composition at the target location. In some aspects, the first and second composition may react together upon the release of the first composition at the target location.

### TECHNICAL FIELD

This invention is generally concerned with bringing about an alteration to a composition after that composition, in the form of an emulsion, has been delivered to a target location. Embodiments of the present invention relate to a method of delivering a material to a target location by emulsifying the material, transporting the emulsion to the target location and then disrupting the emulsion. Other embodiments relate to altering viscosity at a target location. The invention also extends to the emulsions themselves. The invention has particular applicability in connection with exploration for oil and gas, and the production and transport of oil and gas.

### BACKGROUND

At various stages of the drilling, completion and operation of wellbores for extracting natural hydrocarbons such as oil and gas, it is desirable to transport one or more materials, which may be termed ‘oilfield chemicals’ to target locations, which are often underground, for a wide variety of purposes. For example it may be desired to deliver a chemical or an enzyme to a target location to bring about a cross-linking or breaking reaction and thereby to increase or decrease the viscosity of a polymer solution at that location.

However, it is often the case that the desired effect of the active chemical is only required to be exhibited once at the target location and in some applications it is essential that this is the case. Thus, the controlled or triggered release of oilfield chemicals is of great importance.

Many methods of controlled release have been devised which rely on the contrast between the environmental conditions downhole and those at the surface, e.g. in terms of temperature and pressure. However, such changes may be somewhat gradual and are not susceptible to control.

One approach to providing controlled release is to employ an emulsion of one fluid within another fluid. Typically, an emulsion containing a dispersed phase is transported to the target underground location and the emulsion is physically disrupted by use of controlled shear to release the dispersed phase. The dispersed phase may contain or consist of the oilfield chemical which it is desired to deliver.

U.S. Pat. No. 6,464,009 discloses such emulsions which are used together with drilling muds, to release an agent downhole, in the vicinity of the drill bit, by action of the very high shear encountered there.

U.S. Pat. No. 6,364,020 discloses an emulsion having at least two discontinuous phases which are brought into contact and allowed to react to form a gel by disrupting the emulsion with high shear forces at a specified underground location.

However, the use of shear as a mechanism to cause break-up of the emulsions restricts the range of applications possible. The emulsion properties must be highly optimised so that the emulsion is not disrupted during transport to the target underground location yet is fully disrupted once subjected to high shear at the target location.

There are also circumstances where it is desired to alter the viscosity of a composition at a chosen target location. Currently, this may be done by manipulation of the chemistry of the composition. For example U.S. Pat. No. 7,290,615 describes compositions which have high viscosities at one pH range and low viscosities at another pH range. These may be used for coiled tubing wellbore cleanout. For this procedure, a viscous fluid is injected into a wellbore; the fluid entrains particles and carries them to the surface; the viscosity of the fluid is reduced by reducing or increasing the pH; the particles settle from the fluid. After this the viscosity of the fluid may be increased by increasing or reducing the pH and the fluid re-injected into the wellbore.

### SUMMARY OF THE INVENTION

In a first aspect, the invention provides a method of providing a composition which undergoes alteration at a target location, comprising dispersing a first material in a second material in the presence of emulsion-stabilising particles, wherein the particles are responsive to a magnetic field, transporting the emulsion to the target location and exposing the emulsion to a magnetic field sufficient to disrupt the emulsion and thereby alter the composition at the target location.

Emulsions which are stabilised with particles are sometimes referred to as Pickering emulsions. The particles are smaller than the droplets of the dispersed phase of the emulsion, and are located at the interface between the dispersed and continuous phases where they served to stabilise the emulsion.

By employing particles responsive to a magnetic field to stabilise the emulsion, the composition of the emulsion can be transported intact to the target location and then disrupted by exposure to a magnetic field. Thus the location where the composition undergoes alteration is directly controlled by choosing the position at which a magnetic field is provided.

In some embodiments the objective of the alteration of the composition is a reduction in viscosity, consequent on disrupting the emulsion. If so, the target location may be at the surface, and reducing viscosity may allow entrained solids to settle out at the surface. The emulsion may subsequently be reformed, so as to allow the composition to be re-used.

Other embodiments of the present invention relate to a method of delivering a first material to a target location, comprising dispersing the first material into a second material, thereby to form an emulsion, stabilising the emulsion with particles responsive to a magnetic field, transporting the emulsion to the target location and exposing the emulsion to a magnetic field sufficient to disrupt the emulsion, and thereby release the first material at the target location. For such forms of the invention the first material may be intended to interact with something else upon release at target location. For example the first material may be a chemical or an enzyme intended to bring about a chemical change at the target location.

In such embodiments, exposure to a magnetic field disrupts the emulsion and triggers the release of at least the dispersed first material. This allows direct control of the location of release, e.g. by locating a means for providing a magnetic field at the chosen target location.

Typically the target location for release of a first material to interact at a target location will be located underground in a wellbore or in a reservoir penetrated by a wellbore and transport to the target location may be along such a wellbore. However it may also be located in a pipeline or other location of an inaccessible nature.

The emulsion may be a simple dispersion of the first material as a dispersed phase within a continuous phase of the second material. Alternatively the emulsion may be more complex and comprise a further dispersed phase, which may be dispersed within the second material or within the first material, as a so-called multiple emulsion. Each dispersed material may be a single substance or may be a composition, for instance a solution of an active chemical in a solvent. The continuous phase of the emulsion may also be a single material or may be a composition containing a plurality of materials.

The emulsion may comprise any suitable phases which form an emulsion. Typically this will be achieved by use of one or more hydrophilic phases and one or more hydrophobic phases, conveniently referred to as water and oil phases for short, although this need not always be the case.

A variety of types of emulsion can be envisaged, e.g. an oil-in-water, water-in-oil, water-in-oil-in-water or oil-in-water-in-oil emulsion. Also, as discussed, more than one water phase may be dispersed in an oil phase or more than one oil phase may be dispersed in a water phase.

Thus, in a second aspect, the invention relates to an emulsion comprising at least two phases comprising a first material in a first phase and a second material in a second phase separated by a phase boundary, the emulsion being stabilised by particles responsive to a magnetic field.

Once triggered and at least the first dispersed material is released, any of a number of possible effects can result. One possibility is that the released material may interact with something already present at the target location. Such interaction is likely to be a chemical reaction.

For example, acids are commonly used in downhole environments, e.g. to attack the surface of formation rock or as a breaker to destroy blocking gels. The present invention could be employed to convey acid as the dispersed phase in an emulsion and release that acid at a target location which is at the end of a work string. Because the acid is conveyed as the dispersed phase within the emulsion, the work string is largely protected from corrosion by the acid.

However, in some significant embodiments of the present invention the dispersed phase and another phase in the emulsion composition are capable of interacting after (but not before) of the emulsion is broken by exposure to any magnetic field.

Thus, in a third aspect, the invention relates to an emulsion comprising a first material in a first phase and a second material in a second phase, stabilised by particles responsive to a magnetic field, wherein the first and second materials are capable of interacting with each other after disruption of the emulsion brings them into contact.

In some preferred embodiments, material within a dispersed phase reacts with material in another phase to produce a gel downhole. Gels are used in a wide range of situations which may develop when drilling, completing or operating wellbores, for example fracturing formations, and more especially plugging operations. Plugging wellbores may be desirable in a number of situations, such as to redirect flow around lost equipment, to initiate directional drilling in a weak formation, to plug back a zone or plug a complete well for abandonment, to cure a lost circulation problem encountered during drilling, or to provide a test anchor when a weak formation exists in an open hole below the zone to be tested.

The emulsion may comprise an aqueous solution of thickening polymer, possibly a thickening polysaccharide such as guar, as the continuous phase of the emulsion, while the discontinuous phase of the emulsion contains a cross-linking agent for the polymer. When the emulsion is disrupted by the magnetic field the cross-linking agent is released and it is able to cross-link the polymer to form a gel and increase viscosity further.

Typically gelling will be carried out by cross-linking polymers, typically water-soluble polymers. The types, kinds of ways such gels can be delivered downhole in emulsion form are described in U.S. Pat. No. 6,364,020, discussed above.

Other applications to which the present invention can be applied may be the initiation of setting of cement, by release of an accelerant at a target location which is the shoe of a cementing stage, or to stabilise supercritical CO₂/water emulsions when surfactants are difficult to use in view of their temperature sensitivity.

The emulsions of the present invention are made in a manner which is already known for making Pickering emulsions, but with particles which are responsive to a magnetic field used for stabilising the interfaces between separate phases. Emulsions which are stabilised with particles at the interface between phases have been reviewed in the scientific literature, see for example Aveyard et al., Advances in Colloid and Interface Science Vols 100-102 (2003) pages 503-546, the disclosure of which is incorporated herein by reference. The particles which stabilise the emulsion should have small size so that they can position themselves at the interface between two phases and they should have a surface hydrophobicity/hydrophilicity which is intermediate between the hydrophobicities/hydrophilicities of the two phases. In consequence of this the contact angles between the stabilising particles and the separate phases will be significantly above 0° and significantly below 180°.

The character of the stabilizing interface may be varied by using different particle sizes and contact angles with the fluids of the emulsion. Contact angles less than 90° tend to stabilise oil-in-water emulsions and contact angles of greater than 90° tend to stabilise water-in-oil emulsions. As such, in different embodiments of the present invention, the parameters of the particles may be adjusted to provide the desired stabilization properties for the emulsions.

The stabilising particles may have sizes from 0.001 to 10.0 microns, and preferably from 0.01 to 5.0 microns. Additionally, functionalisation of the particles' surface can be employed to alter the contact angle as necessary. In certain aspects, methods to chemically modify the surfaces of the magnetic particles to obtain a required contact angle, such as treatment with an organosilane, are used.

In one embodiment of the present invention, the emulsion is of the water-in-oil-in-water type and the two water phases comprise first and second compositions respectively which react together to form a gel. To form multiple emulsions more than one type of particle, each having a contact angle appropriate for its interface, may be used.

The emulsions according to embodiments of the present invention are configured to be stable until they are exposed to a magnetic field of a sufficient strength. The magnetic field induces a force on the particles which greatly exceeds the interfacial tension forces holding the particles in place and, as a result, “strips” the particles from the dispersed phase as the particles are attracted to a magnetic pole.

In some embodiments of the present invention, the magnetic field may be established at the target location by installing a permanent magnet at the target location (which may be located downhole) the installed magnet triggering the disruption of the emulsion as the emulsion is pumped past the magnet. Such embodiments do not require the transmission of any power to a downhole target location, nor do they require surface control/initiation of the magnet. In some embodiments, however, the magnetic field generated by a downhole magnet could be suppressed by a metallic “keeper” which could be slid over the magnet when triggering of the downhole event is not required, which may prevent fouling of the magnet and/or the like, and moved out of the way at a time when triggering of the downhole destabilizing of the emulsion system is desired.

In alternative embodiments, an electromagnet may be used. In such embodiments, an electrical circuit may be used to activate the magnet to trigger the magnetic field and the destabilization of the emulsion system.

In aspects of the present invention, the magnetic field strength used in the present methods and systems may be tailored to provide adequate disruption of the emulsions to provide the desired downhole event. Magnet field strength being determined for such aspects according to a number of factors, such as magnetic permeability of the fluid medium, particle volume, and saturation magnetisation. In other aspects, experimentation and/or modeling may be used to select the magnetic field strength.

In order for the particles of embodiments of the present invention to respond sufficiently to disrupt the emulsion when exposed to a magnetic field, in certain aspects the particles may have a saturation magnetisation of at least 20 Am²/kg, and in other aspects at least 50 Am²/kg. In some embodiments, iron particles may be used, which have a saturation magnetisation of 211 Am²/kg. Other magnetic solids such as barium ferrite (BaFe₁₂O₁₄, saturation magnetisation of 60 Am²/kg) or magnetite (Fe₃O₄, saturation magnetisation of 90 Am²/kg) may also be used.

### BRIEF DESCRIPTION OF THE DRAWINGS

The invention will now be illustrated, by way of example, with reference to the drawings, in which:

FIG. 1 is a schematic representation of a pipe, with an emulsion according to the invention being disrupted by a magnetic field;

FIG. 2 is a detail showing a magnet with a keeper;

FIG. 3 diagrammatically illustrates application of the invention when pumping fluid into a subterranean reservoir to form a fracture;

FIG. 4 diagrammatically illustrates application of the invention when using coiled tubing to perform a wellbore cleanout; and

FIG. 5 shows rheograms obtained with an unbroken, and a broken emulsion.

### DETAILED DESCRIPTION

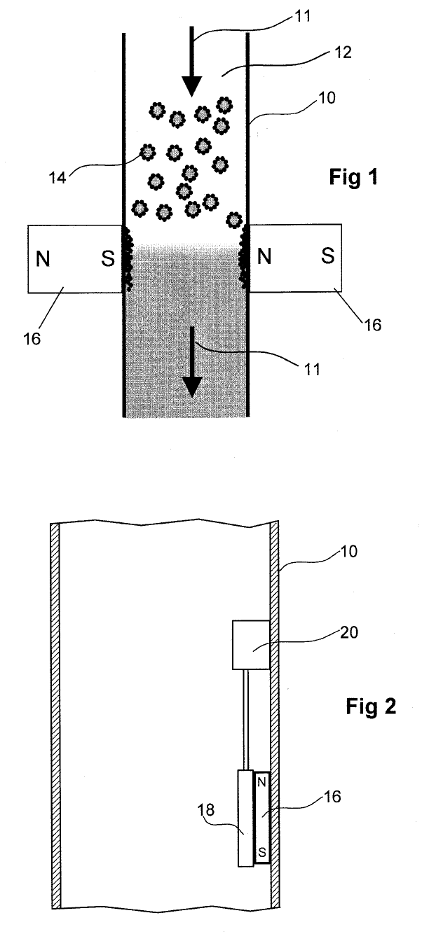

FIG. 1 shows a cylindrical pipe 10 which may be part of a wellbore, aligned vertically and having an emulsion 12 flowing downwardly through the pipe 10 as indicated by arrows 11. The emulsion 12 comprises a dispersed phase 14 comprising droplets of a first composition surrounded by stabilising iron particles and suspended in a continuous phase of a second composition. Thus the first composition is kept physically separated from the second composition as it flows down the wellbore 10. Positioned at the target location are a pair of permanent magnets 16 which induce a magnetic field between them.

As the emulsion 12 enters the magnetic field, the iron particles are attracted to one of the permanent magnets 16 with a force greater then the surface tension forces holding the iron particles in place around the dispersed phase droplets. In consequence the iron particles are stripped from the dispersed phase particles 14 and captured by one of the permanent magnets 16. The emulsion is disrupted and the first composition then mixes with the second composition.

FIG. 2 illustrates the use of a single bar magnet 16, provided with an iron keeper 18 so that there is insufficient magnetic field within the pipe 10 to strip iron particles from disperse phase droplets. When it is required to disrupt the emulsion, an actuator 20 is operated to slide the keeper 18 off the magnet 16.

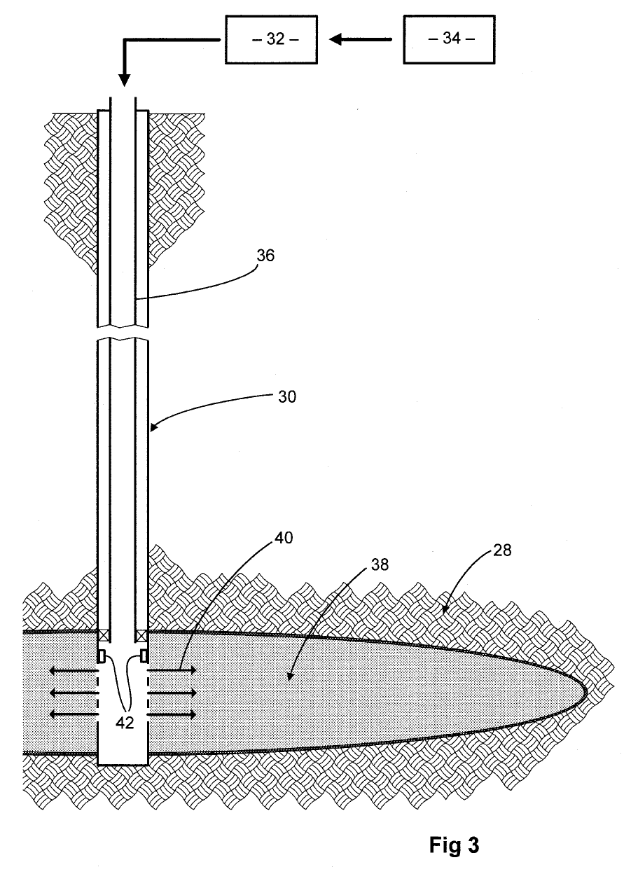

FIG. 3 diagrammatically illustrates use of the invention in the context of fracturing a reservoir formation 28. As is conventional for a fracturing job, hydrocarbon production from an existing wellbore 30 is halted and the well head is coupled to pumps 32 supplied by a mixer 34. This mixer is used to mix guar as a thickening polymer into water to form a thickened fracturing fluid which is pumped down the production tubing 36 within the wellbore 30 and exits into the fracture 38 as indicated by the arrows 40 at the foot of the well. The mixer 34 may also mix a particulate solid proppant into the fluid.

In current practice, it would be normal to use the mixer 34 to mix in a delayed release cross-linking agent which crosslinks the guar after entry to the fracture 38, causing a further increase in viscosity. Delaying interaction of the thickener and cross-linking agent limits the viscosity of the fluid flowing in the wellbore tubing.

In the arrangement illustrated here, a hydrophobic phase containing the cross-linking agent is added to the mixer 34 together with stabilising iron particles, so that the fluid which is pumped down the wellbore 30 is an emulsion of the hydrophobic phase dispersed phase within the aqueous fluid and stabilised by the iron particles which position themselves at the surface of the dispersed phase droplets. Downhole, just before the fluid leaves the wellbore and enters the fracture 38, it passes a pair of permanent magnets 42 which capture the stabilising iron particles, disrupting the emulsion and allowing the cross-linking agent to react with the guar after the fluid has entered the fracture 38.

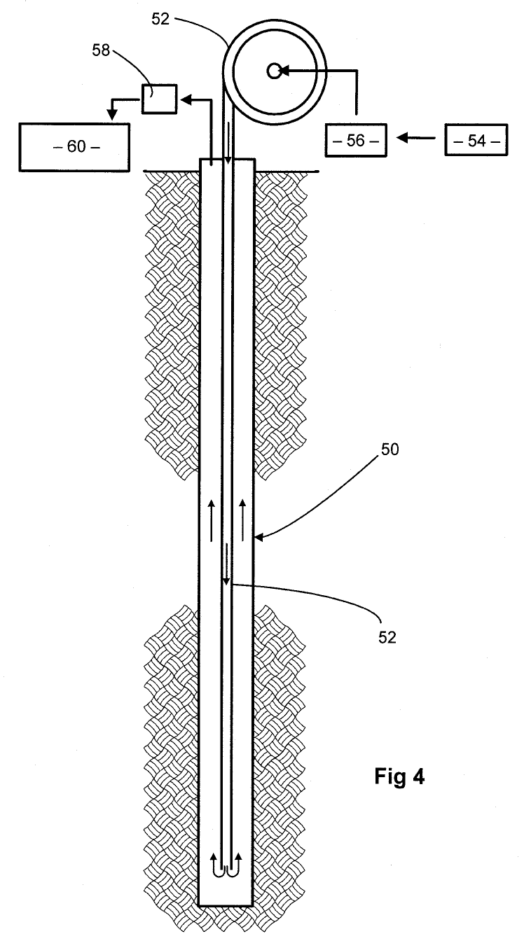

FIG. 4 diagrammatically illustrates use of the invention in the context of wellbore cleanout. It is desired to remove sand and debris from the foot of a wellbore 50. Coiled tubing 52 is inserted into a wellbore 50. An emulsion of a hydrophobic oil, dispersed in water and stabilised by iron particles is prepared in a mixer 54 and pumped into and down the coiled tubing 52 by means of pumps 56. At the foot of the wellbore 50, this fluid is discharged from the coiled tubing 52, entrains sand and debris particles and rises up the annulus around the coiled tubing 52. On return to the surface the fluid passes through an electromagnet 58 which captures the iron particles and disrupts the emulsion, with consequent drop in viscosity. The fluid then flows into a settling tank 60 where the entrained solids settle out. If desired the fluid constituents from the tank 60 may be recycled to the mixer 54.

### EXAMPLE 1

In an example of the present invention, iron particles with a diameter around 2 microns from Sigma-Aldrich (this was so-called ‘carbonyl iron’ obtained by decomposition of iron carbonyl) were used for stabilizing a water-in-oil emulsion. In order to obtain a water-in-oil (rather than oil-in-water) emulsion, the particles were surface-modified by treatment with a 2 wt % solution of n-octyl methyl diethoxy silane in dry methanol for 5 minutes at room temperature followed by removal of the particles from the solution and drying in an oven at 80° C. This resulted in the particles becoming hydrophobic at their surface. A water-in-oil emulsion was then prepared by mixing 2 grams of the hydrophobic iron particles with 5 millilitres of dodecane and 15 millilitres of deionised water, which had been adjusted to pH 12 by addition of potassium hydroxide.

Vigorous agitation gave a water-in-oil emulsion, which was stable for at least a week if left static in a sealed bottle. This emulsion was then added to approximately 100 ml of water with an initial pH of 5.5 and dispersed by gentle stirring so as to form a water-in-oil-in-water emulsion with iron particles stabilising the interface between the two dispersed phases. The pH of the external water phase was monitored. A small degree of transfer between the two water phases during the initial mixing raised the pH to approximately 9 where it stabilized. Application of a strong (2 Tesla) permanent magnet to the outside of the container removed the particles from the oil/water interface. At this time the pH jumped to 11.5 as the potassium hydroxide from the internal water phase mixed completely with the external water phase. The variation of pH with time is shown in the following table:

| Time (mins) | pH |
|---|---|
| 0.0 | 5.50 |
| 1.0 | 8.90 |
| 3.0 | 9.00 |
| 8.0 | 9.10 |
| 17.0 | 9.20 |
| 17.5 | 11.40 |
| 18.0 | 11.50 |
| 20.0 | 11.50 |
| 25.0 | 11.50 |

### EXAMPLE 2

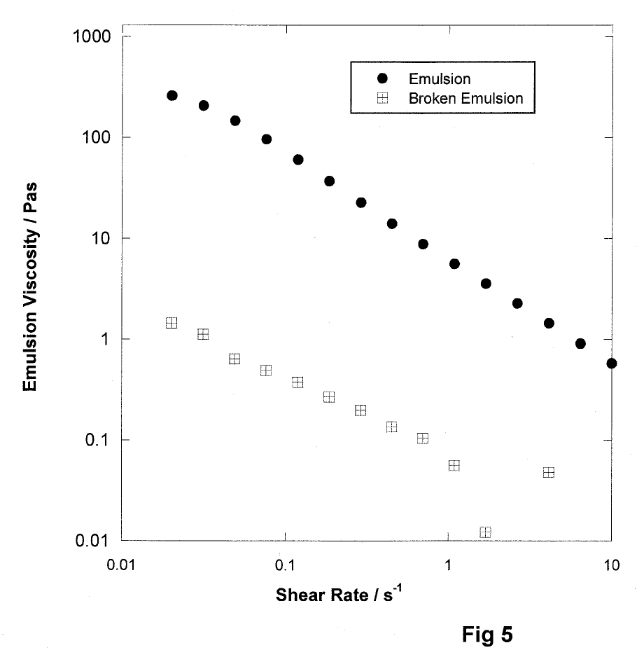

An emulsion was formed by adding 2 g of carbonyl iron particles as supplied by Sigma-Aldrich to 10 ml of de-ionised water and 10 ml of decane and agitating vigorously. This produced an oil-in-water emulsion which was left static to “cream” for about an hour. A sample was then carefully removed from the emulsion layer and transferred to a rheometer (Bholin CVO-R120, 4-40 cone and plate geometry). The viscosity of the sample was measured at shear rates between 0.01 and 10 sec⁻¹. The rest of the emulsion layer was then subjected to a magnetic field strong enough to remove all the iron particles. A sample of the resulting fluid was placed in the rheometer and its viscosity measured. The two rheograms are shown in FIG. 5. It can be seen that removing the iron particles reduced the viscosity of the fluid by approximately two orders of magnitude.

While the principles of the disclosure have been described and exemplified above in connection with specific apparatuses and methods, it is to be clearly understood that this description is made only by way of example and not as limitation on the scope of the invention.

1. A method of effecting alteration of a composition at a target location, comprising dispersing a first material in a second material in the presence of emulsion-stabilising particles, wherein the particles are responsive to a magnetic field, transporting the emulsion to the target location and exposing the emulsion to a magnetic field sufficient to disrupt the emulsion at the target location.

2. A method according to claim 1 wherein disruption of the emulsion reduces the viscosity of the composition.

3. A method according to claim 1 wherein the first and second materials both comprise one or more constituents and disruption of the emulsion is followed by interaction between a constituent of the first material and a constituent of the second material.

4. A method according to claim 1, wherein the target location is located underground in a wellbore.

5. A method according to claim 1, wherein the particles have a mean particle size of from 0.001 to 10.0 microns.

6. A method according to claim 1, wherein the particles have a saturation magnetisation of at least 20 Am²/kg.

7. A method of delivering a first material to a target location, comprising dispersing the first material into a second material in the presence of emulsion-stabilising particles, wherein the stabilising particles are responsive to a magnetic field, transporting the emulsion to the target location and exposing the emulsion to a magnetic field sufficient to disrupt the emulsion, and thereby release the first material at the target location.

8. A method according to claim 7 wherein the first material is an aqueous composition comprising a thickening polymer and the second material is a hydrophobic phase comprising a cross linking agent for the thickening polymer.

9. A method according to claim 7, wherein the emulsion comprises at least two discontinuous phases.

10. A method according to claim 7, wherein the magnetic field is induced by a permanent magnet located at the target location.

11. A method according to claim 10, wherein the magnetic field is prevented from inducing a magnetic field by the presence of a metallic keeper, which is removed to expose the emulsion to the magnetic field.

12. A method according to claim 7 wherein the magnetic field is induced by an electromagnet located at the target location.

13. A method according to claim 7, wherein the target location is located underground in a wellbore.

14. A method according to claim 7, wherein the first and second materials react together when brought into contact.

15. A method according to claim 14, wherein the first and second materials react together to form a gel.

16. A method according to claim 7, wherein the particles have a mean particle size of from 0.001 to 10.0 microns.

17. A method according to claim 7, wherein the particles have a saturation magnetisation of at least 20 Am²/kg.

18. An emulsion comprising at least two discontinuous phases comprising a first composition in a first phase and a second composition in a second phase separated by at least two phase boundaries, the emulsion being stabilised by particles responsive to a magnetic field.

19. An emulsion comprising a first composition in a first phase and a second composition in a second phase, stabilised by particles responsive to a magnetic field, wherein the first and second compositions are capable of reacting together when brought into contact.
